(19) United States
(12) Patent Application Publication
(10) Pub. No.: US 2016/0095156 A1
(43) Pub. Date: Mar. 31, 2016

(54) OUT-OF-SERVICE SCAN OPTIMIZATION USING BROADCAST NEIGHBOR LIST INFORMATION IN WIRELESS COMMUNICATIONS

(71) Applicant: QUALCOMM Incorporated, San Diego, CA (US)

(72) Inventors: Soumen Mitra, Hyderabad (IN); Aritra Ukil, Hyderabad (IN); Jun Hu, San Diego, CA (US); Rashid Ahmed Akbar Attar, San Diego, CA (US); Anand Rajurkar, Hyderabad (IN); Vamsi Krishna Chaitanya Komati, Hyderabad (IN); Ajay Reddy, Hyderabad (IN)

(21) Appl. No.: 14/499,983

(22) Filed: Sep. 29, 2014

(51) Int. Cl. H04W 76/02; H04W 52/02

(52) U.S. Cl. CPC H04W 76/028; H04W 52/0241; H04W 84/042

(57) ABSTRACT

Aspects of the present disclosure provide an improved out-of-service (OOS) scan method that can increase the speed of acquiring service while avoiding unnecessary full scan, thus reducing scan time and/or power consumption of a user equipment. In one aspect of the disclosure, if a user equipment fails to acquire service after scanning a most recently used (MRU) list, the user equipment scans for the networks or cells stored in a neighbor list before performing a wider scan or a full scan.

### TECHNICAL FIELD

The technology discussed below relates generally to wireless communication systems, and more particularly, to out-of-service scan and service acquisition in wireless communications.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks. Other examples of radio access technologies are CDMA2000 (1×), CDMA 2000 EV-DO (DO), Long-Term Evolution (LTE), etc.

Some wireless communication terminals can support multiple networks using one or more radio access technologies (RATs). Examples of such multimode communication terminals are 1×/DO Hybrid user equipment and Multi-SIM user equipment. A Multi-SIM user equipment has multiple subscriber identity modules (SIMs), SIM cards, or Universal Integrated Circuit Cards (UICCs). One particular example is the Dual-SIM Dual-Standby (DSDS) user equipment. A DSDS user equipment can be simultaneously standby on two networks, but can be active only on one network at a time.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide an improved out-of-service (OOS) scan method and apparatuses that can increase the speed of acquiring service while avoiding unnecessary full scan, thus reducing scan time and/or power consumption of a user equipment.

An aspect of the disclosure provides a method for performing an out-of-service (OOS) scan at a user equipment (UE). The UE scans one or more first channels to acquire service based on a most recently used (MRU) list. If the UE fails to acquire service after scanning the one or more first channels, the UE scans one or more second channels to acquire service based on a neighbor list. Furthermore, if the UE fails to acquire service after scanning the one or more second channels, the UE scans a plurality of third channels not included in the MRU list and the neighbor list.

Another aspect of the disclosure provides an apparatus configured to perform an out-of-service (OOS) scan. The apparatus includes means for scanning one or more first channels to acquire service based on a most recently used (MRU) list. The apparatus further includes means for if the apparatus fails to acquire service after scanning the one or more first channels, scanning one or more second channels to acquire service based on a neighbor list. The apparatus further includes means for if the apparatus fails to acquire service after scanning the one or more second channels, scanning a plurality of third channels not included in the MRU list and the neighbor list.

Another aspect of the disclosure provides a computer-readable storage medium including code for causing a user equipment (UE) to perform an out-of-service (OOS) scan. The code causes the UE to scan one or more first channels to acquire service based on a most recently used (MRU) list. The code further causes the UE to if the UE fails to acquire service after scanning the one or more first channels, scan one or more second channels to acquire service based on a neighbor list. The code further causes the UE to if the UE fails to acquire service after scanning the one or more second channels, scan a plurality of third channels not included in the MRU list and the neighbor list.

Another aspect of the disclosure provides a user equipment (UE) configured to perform an out-of-service (OOS) scan. The UE includes at least one processor, a shared communication resource coupled to the at least one processor for communicating with a first network and a second network, and a memory coupled to the at least one processor. The memory includes an OOS scan program. The processor is configured by the OOS scan program to scan one or more first channels to acquire service based on a most recently used (MRU) list. The processor is further configured to if the UE fails to acquire service after scanning the one or more first channels, scan one or more second channels to acquire service based on a neighbor list. The processor is further configured to if the UE fails to acquire service after scanning the one or more second channels, scan a plurality of third channels not included in the MRU list and the neighbor list.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a drawing illustrating a first radio access technology (RAT) communication and a second RAT communication at a user equipment (UE) in accordance with an aspect of the disclosure.

FIG. 2 is a drawing illustrating a scenario in which a UE moves away from an initial RAT coverage area during a voice call in accordance with aspects of the disclosure.

FIG. 3 is a block diagram illustrating an example of a telecommunications system in accordance with an aspect of the disclosure.

FIG. 4 is a diagram illustrating an example of an access network in accordance with aspects of the disclosure.

FIG. 5 is a block diagram illustrating a UE configured to perform improved out-of-service (OOS) scan procedures in accordance with aspects of the disclosure.

FIG. 6 is a block diagram illustrating an example of a hardware implementation for an apparatus employing a processing system in accordance with an aspect of the disclosure.

FIG. 7 is a flow chart illustrating an OOS scan method operable at a UE in accordance with aspects of the disclosure.

FIG. 8 is a drawing illustrating a scenario in which a UE performs an OOS scan procedure in accordance with aspects of the disclosure.

FIG. 9 is a flow chart illustrating an OOS scan method utilizing neighbor list information to reduce scan time and/or power consumption in accordance with aspects of the disclosure.

FIG. 10 is a drawing illustrating a method of maintaining a neighbor list in accordance with an aspect of the disclosure.

FIG. 11 is a drawing illustrating a neighbor list sorted using the method of FIG. 10 in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the disclosure relate to a user equipment that can support wireless communications utilizing one or more radio access technologies (RATs) such as W-CDMA, 1×, EV-DO, HSPA, LTE, etc. Non-limiting examples of such user equipment include multimode, hybrid, and multi-SIM user equipment. In some situations, when such user equipment communicates (e.g., a voice call) with a first network utilizing a first RAT, the user equipment may not be able to receive signals (e.g., paging messages or signaling messages) from a second network utilizing a second RAT. Therefore, the user equipment may become out-of-service with respect to the second network. Some aspects of the disclosure provide a user equipment that can perform an improved out-of-service (OOS) scan to acquire or reacquire service faster, thus saving power and/or time used for acquiring service.

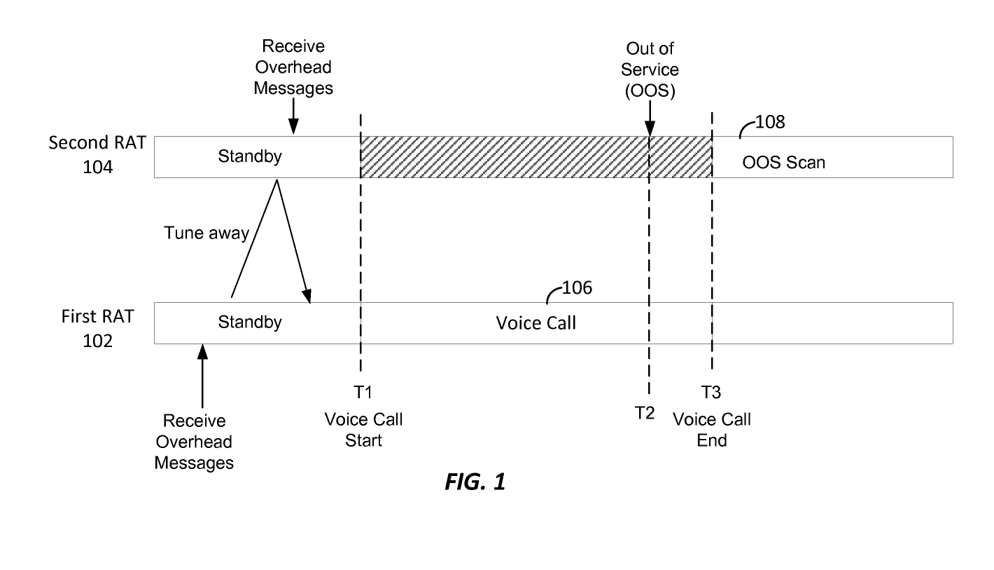

FIG. 1 is a drawing illustrating a multimode user equipment (UE) utilizing a first RAT and a second RAT to communicate with respective networks in accordance with an aspect of the disclosure. For example, the UE may be camped on a first network associated with a first RAT 102, and a second network associated with a second RAT 104. In some examples, the first RAT 102 and second RAT 104 may be the same or different access technology. When the UE is camped on a network, it can utilize communication services from that network. Initially, the UE may be in an idle state (standby) on both networks and receive overhead messages (e.g., paging messages or signaling messages) from one or both networks. For example, the UE may use a tune-away procedure to share a communication resource (e.g., an RF chain, a transceiver, etc.) in a time-multiplexed fashion to communicate with the first and second networks.

The overhead messages may include neighbor list information. The neighbor list information provides various information of the neighbor cells that the UE may select during a handover procedure. For example, the neighbor list information may include the channels, bands, and frequencies of the neighbor cells. In one example, the UE may start a voice call 106 on the first network at time T1 utilizing the first RAT 102. During the voice call, the UE may not be able to transmit and/or receive signals utilizing both the first RAT 102 and second RAT 104 simultaneously. Therefore, if the voice call continues for a substantially long time, the UE may become out-of-service (OOS) on the second network at time T2. After the voice call ends at time T3, the UE may perform an OOS scan 108 to reacquire service on the second network utilizing the second RAT 104. In one example, the first RAT 102 and second RAT 104 may be GSM and UMTS, respectively. In another example, the first RAT 102 and second RAT 104 may be 1× and DO, respectively. In another example, the voice call may be a circuit-switched fallback call on the second network. In a circuit-switched fallback call, for example, the second RAT 104 may provide only data services, and when a voice call is to be initiated or received, the UE can fall back to the first RAT 102, which can support a circuit-switched call.

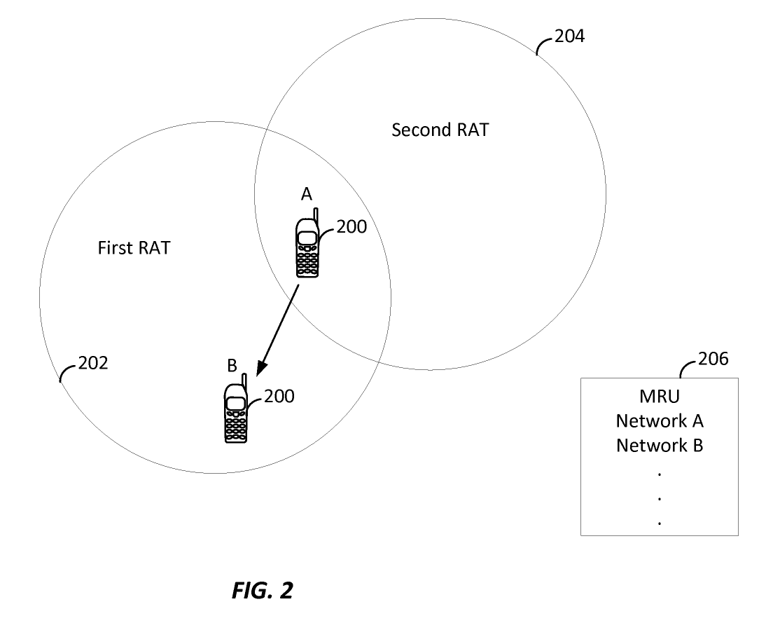

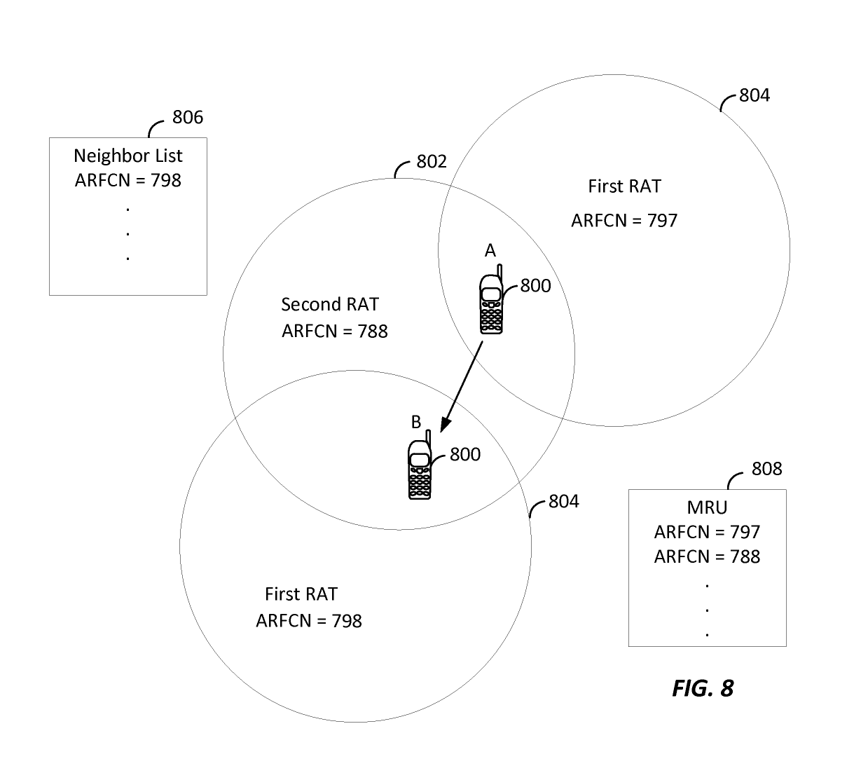

In general, the UE starts an OOS scan with a Most Recently Used (MRU) list (e.g., MRU 206 of FIG. 2 and MRU 808 of FIG. 8). The MRU list stores information of networks or cells recently camped on (i.e., acquired service) by the UE within a certain geographic area. For example, the MRU list may include a listing of one or more networks to which the UE recently camped on. The MRU list may include the RAT, mode, frequency, band, and/or channel information for each network included in the MRU list. In one non-limiting example, the MRU list may include information for the ten most recently used networks. For example, the MRU list may include the modes (e.g., W-CDMA, HSPA, HSPA+, LTE, CDMA 1×, EV-DO, etc.), band classes (cellular, PCS, GSM, etc.), and channels (e.g., ARFCNs) of the most recently used networks. In one example, the UE may maintain one combined MRU list for both RAT 102 and RAT 104, or separate MRU lists for each RAT supported by the UE.

FIG. 2 is a drawing illustrating a scenario in which a UE 200 moves away from an initial RAT coverage area during a voice call in accordance with aspects of the disclosure. The UE 200 may be a DSDS UE. The UE 200 may be any of the UEs illustrated in FIGS. 1, 2-6, and/or 8. The UE 200 may initiate or receive a voice call at the position A at a certain time (e.g., at time T1 of FIG. 1). At the position A, before the voice call, the UE 200 can receive overhead information from a first network associated with a first RAT 202 and a second network associated with a second RAT 204. For example, the overhead information may be overhead signaling messages from the network via signaling or control channels. In an EV-DO network, some examples of the overhead messages are the SYNC, QuickConfig, SectorParameters message, and AccessParameters message. The SectorParameters message may have the neighbor list information. The SectorParameters message provides information about the current sector's identity, neighbors, number of channels supported.

In FIG. 2, the coverage area (cell 1) of the first RAT 202 partially overlaps with the coverage area (cell 2) of the second RAT 204. In one example, the UE 200 may maintain one or more MRU lists based on the overhead information received from the network. For example, the UE 200 may maintain an MRU list 206 that stores information for the recently used networks, for example, network A and network B. In this particular example, the network A may correspond to the cell 2. In some examples, the UE 200 may use the same MRU list 206 for both RATs 202 and 204. The first RAT 202 may be the same as the first RAT 102 of FIG. 1, and the second RAT 204 may be the same as the second RAT 104 of FIG. 1. In other examples, the UE 200 may maintain multiple MRU lists each associated with one or more networks.

During the voice call utilizing the first RAT 202, the UE 200 may move to the position B where it is no longer within the coverage area (cell 2) of the second RAT 204. Therefore, the UE 200 may become OOS at a certain time (e.g., time T2 of FIG. 1) with respect to the second RAT 204. When the UE 200 is OOS, it can no longer communicate with the network (cell 2) associated the second RAT 204. After the voice call is ended at a certain time (e.g., time T3 of FIG. 1), the UE 200 may perform an OOS scan procedure (e.g., OOS scan 108 of FIG. 1) to reacquire service utilizing the second RAT 204. In general, the UE 200 first scans for service using the MRU list 206. That is, the UE 200 will first try to reacquire service from the networks listed in the MRU list 206 by scanning the associated channels. However, the UE 200 may not be able to reacquire service from cell 2 of the second RAT 204 because the UE 200 has already moved away from the cell 2 coverage area. If the UE 200 cannot reacquire service after exhausting the MRU list 206 (i.e., scanned for all the networks/cells of the MRU list), a UE may start a more extensive scan (e.g., full scan). However, a wider scan or full scan will undesirably increase the total scan time and power consumption of the UE.

Aspects of the present disclosure provide an improved OOS scan method that can increase the speed of acquiring service while avoiding unnecessary full scan, thus reducing scan time and/or power consumption of a UE. In one aspect of the disclosure, if a UE fails to acquire service after scanning an MRU list, the UE scans for the networks/cells stored in a neighbor list before performing a wider scan or a full scan. This improved OOS scan method will be described in more detail below with some non-limiting examples.

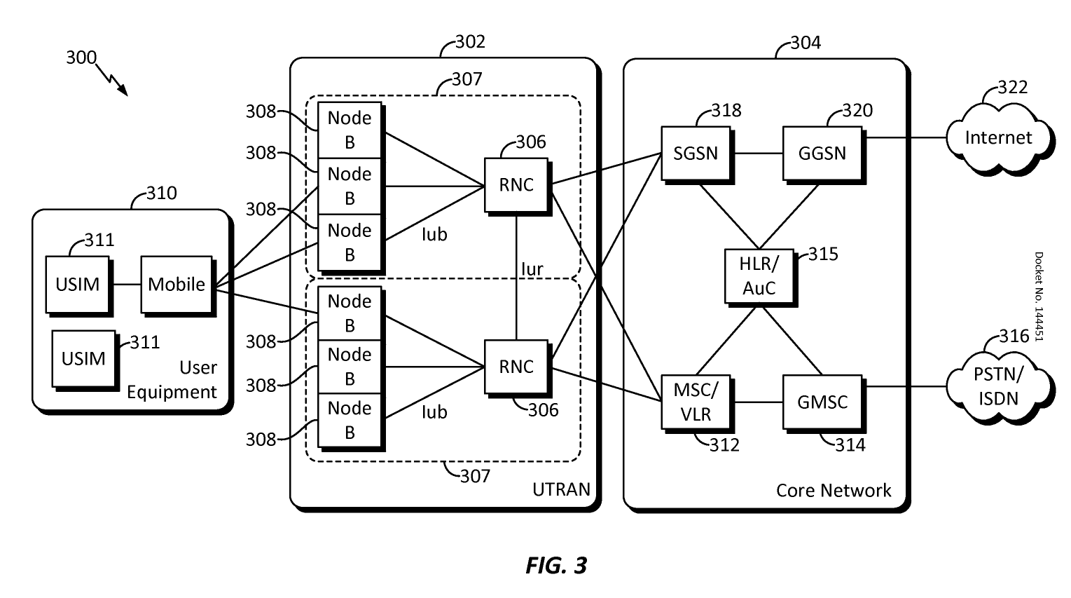

The various concepts presented throughout this disclosure may be implemented across a broad variety of telecommunication systems, network architectures, and communication standards. Referring now to FIG. 3, as an illustrative example without limitation, various aspects of the present disclosure are illustrated with reference to a Universal Mobile Telecommunications System (UMTS) system 300. A UMTS network includes three interacting domains: a core network 304, a radio access network (RAN) (e.g., the UMTS Terrestrial Radio Access Network (UTRAN) 302), and a user equipment (UE) 310. The UE 310 may be a DSDS UE or any UE illustrated in any one of the FIGS. 2, 4-6, and/or 8. Among several options available for a UTRAN 302, in this example, the illustrated UTRAN 302 may employ a W-CDMA air interface or RAT for enabling various wireless services including telephony, video, data, messaging, broadcasts, and/or other services. The UTRAN 302 may include a plurality of Radio Network Subsystems (RNSs) such as an RNS 307, each controlled by a respective Radio Network Controller (RNC) such as an RNC 306. Here, the UTRAN 302 may include any number of RNCs 306 and RNSs 307 in addition to the illustrated RNCs 306 and RNSs 307. The RNC 306 is an apparatus responsible for, among other things, assigning, reconfiguring, and releasing radio resources within the RNS 307. The RNC 306 may be interconnected to other RNCs (not shown) in the UTRAN 302 through various types of interfaces such as a direct physical connection, a virtual network, or the like using any suitable transport network. The system 300 may further include a GSM EDGE Radio Access Network (GERAN) for providing GSM access.

The geographic region covered by the RNS 307 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 308 are shown in each RNS 307; however, the RNSs 307 may include any number of wireless Node Bs. The Node Bs 308 provide wireless access points to a core network 304 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, a wearable computing device (e.g., a smartwatch, a health or fitness tracker, etc.), an appliance, a sensor, a vending machine, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 310 may further include a universal subscriber identity module (USIM) 311, which contains a user's subscription information to a network. For illustrative purposes, one UE 310 is shown in communication with a number of the Node Bs 308. The downlink (DL), also called the forward link, refers to the communication link from a Node B 308 to a UE 310 and the uplink (UL), also called the reverse link, refers to the communication link from a UE 310 to a Node B 308.

In some examples, the UE 310 may include multiple USIMs 311 each associated with one or more subscriptions. The UE 310 may be any of the UEs illustrated in FIGS. 2, 4-6, and/or 8. In one particular example, the UE 310 may be a DSDS UE including two USIMs each associated with a corresponding subscription/RAT. The DSDS UE 310 may connect with different networks/subscriptions using different or same RATs. A DSDS UE 310 may be simultaneously attached to or camped on two networks and receives overhead messages from both networks during idle or standby. The UE 310 may use some shared communication resources (e.g., RF front end, transceiver, etc.) to communicate with different networks in a time-multiplexed manner (e.g., using a tune-way procedure). The overhead messages received from the networks may include paging information and neighbor list information. In one example, when the UE 310 is engaged in an active voice call on a first network utilizing a first RAT (e.g., a first RAT 102 of FIG. 1), the UE 310 may not receive or miss messages from a second network associated with a second RAT (e.g., a second RAT 104 of FIG. 1). Therefore, it may become OOS at a certain time. In some aspects of the disclosure, the UE 310 may be configured to support any desired RATs or access networks, for example, UMTS, GSM, 1×, EV-DO, LTE, etc.

The core network 304 can interface with one or more access networks, such as the UTRAN 302. As shown, the core network 304 is a UMTS core network. However, as those skilled in the art will recognize, the various concepts presented throughout this disclosure may be implemented in a RAN, or other suitable access network, to provide UEs with access to types of core networks other than UMTS networks. In some examples, the UE 310 may be connected to the core network 304 using a GSM access network, a GPRS access network, an HSPA access network, or an LTE access network.

The illustrated UMTS core network 304 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 304 supports circuit-switched services with a MSC 312 and a GMSC 314. In some applications, the GMSC 314 may be referred to as a media gateway (MGW). One or more RNCs, such as the RNC 306, may be connected to the MSC 312. The MSC 312 is an apparatus that controls call setup, call routing, and UE mobility functions. The MSC 312 also includes a visitor location register (VLR) that contains subscriber-related information for the duration that a UE is in the coverage area of the MSC 312. The GMSC 314 provides a gateway through the MSC 312 for the UE to access a circuit-switched network 316. The GMSC 314 includes a home location register (HLR) 315 containing subscriber data, such as the data reflecting the details of the services to which a particular user has subscribed. The HLR is also associated with an authentication center (AuC) that contains subscriber-specific authentication data. When a call is received for a particular UE, the GMSC 314 queries the HLR 315 to determine the UE's location and forwards the call to the particular MSC serving that location.

The illustrated core network 304 also supports packet-switched data services with a serving GPRS support node (SGSN) 318 and a gateway GPRS support node (GGSN) 320. General Packet Radio Service (GPRS) is designed to provide packet-data services at speeds higher than those available with standard circuit-switched data services. The GGSN 320 provides a connection for the UTRAN 302 to a packet-based network 322. The packet-based network 322 may be the Internet, a private data network, or some other suitable packet-based network. The primary function of the GGSN 320 is to provide the UEs 310 with packet-based network connectivity. Data packets may be transferred between the GGSN 320 and the UEs 310 through the SGSN 318, which performs primarily the same functions in the packet-based domain as the MSC 312 performs in the circuit-switched domain.

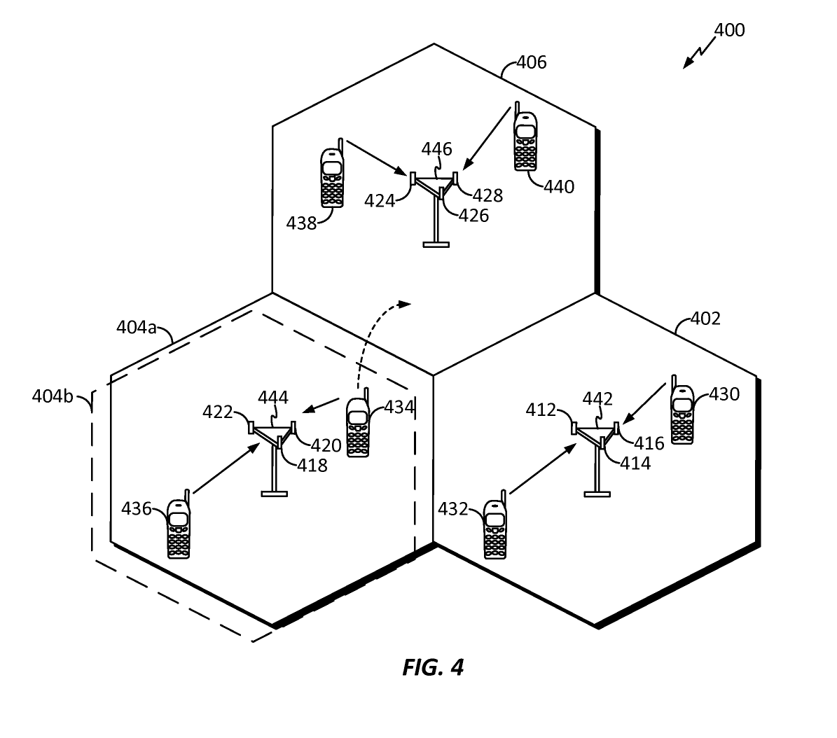

The UTRAN 302 is one example of a RAN that may be utilized in accordance with the present disclosure. Referring to FIG. 4, by way of example and without limitation, a simplified schematic illustration of a RAN 400 in a UTRAN architecture is illustrated. The system includes multiple cellular regions (cells), including cells 402, 404, and 406, each of which may include one or more sectors. Cells may be defined geographically (e.g., by coverage area) and/or may be defined in accordance with a frequency, scrambling code, etc. That is, the illustrated geographically-defined cells 402, 404, and 406 may each be further divided into a plurality of cells, e.g., by utilizing different scrambling codes. For example, cell 404a may utilize a first scrambling code, and cell 404b, while in the same geographic region and served by the same Node B 444, may be distinguished by utilizing a second scrambling code.

In a cell that is divided into sectors, the multiple sectors within a cell can be formed by groups of antennas with each antenna responsible for communication with UEs in a portion of the cell. For example, in cell 402, antenna groups 412, 414, and 416 may each correspond to a different sector. In cell 404, antenna groups 418, 420, and 422 may each correspond to a different sector. In cell 406, antenna groups 424, 426, and 428 may each correspond to a different sector.

The cells 402, 404, and 406 may include several UEs that may be in communication with one or more sectors of each cell 402, 404, or 406. For example, UEs 430 and 432 may be in communication with Node B 442, UEs 434 and 436 may be in communication with Node B 444, and UEs 438 and 440 may be in communication with Node B 446. Here, each Node B 442, 444, and 446 may be configured to provide an access point to a core network 304 (see FIG. 3) for all the UEs 430, 432, 434, 436, 438, and 440 in the respective cells 402, 404, and 406. Any of the UEs illustrated in FIG. 4 may be a multimode, multi-SIM, or DSDS UE illustrated in FIGS. 2, 3, 5, 6, and/or 8.

During a call with a source cell, or at any other time, the UE 436 may monitor various parameters of the source cell as well as various parameters of neighboring cells. Further, depending on the quality of these parameters, the UE 436 may maintain communication with one or more of the neighboring cells. During this time, the UE 436 may maintain an Active Set, that is, a list of cells to which the UE 436 is simultaneously connected (i.e., the UTRAN cells that are currently assigning a downlink dedicated physical channel DPCH or fractional downlink dedicated physical channel F-DPCH to the UE 436 may constitute the Active Set). The UE may also maintain a neighbor set from the network. The neighbor set includes information of a number of neighbor cells or sectors. In one aspect of the disclosure, the UE stores a neighbor list that has the information of the neighbor set while camped on a cell.

The UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. The W-CDMA air interface for the UTRAN 202 is based on such DS-CDMA technology and additionally calls for a frequency division duplexing (FDD). FDD uses a different carrier frequency for the uplink (UL) and downlink (DL) between a Node B 308 and a UE 310. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface or any other suitable air interface.

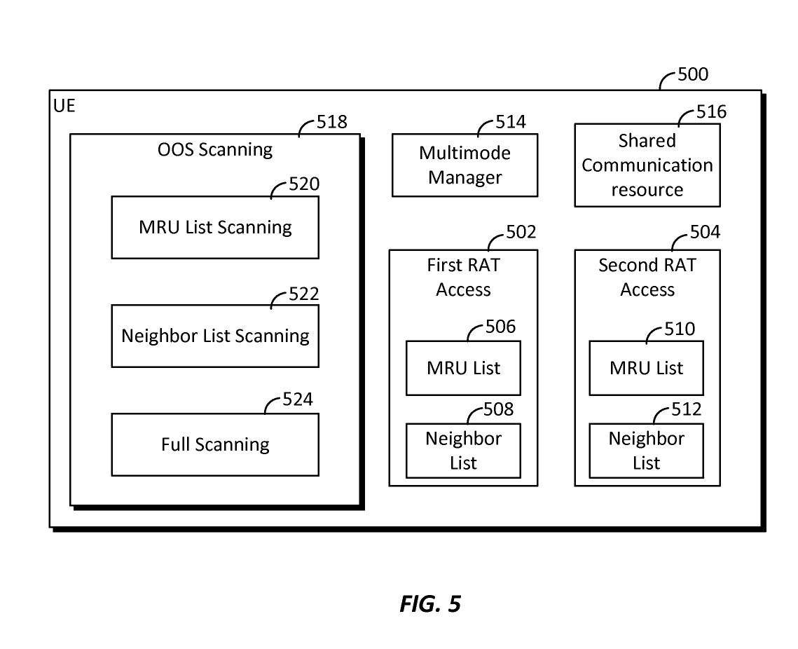

FIG. 5 is a block diagram illustrating a UE 500 configured to perform an improved OOS scan procedure in accordance with some aspects of the disclosure. The UE 500 may be a DSDS UE. The UE 500 may be any of the UEs illustrated in FIGS. 2-4, 6, and/or 8. In one example, the UE 500 may be the same as the UE 200 or UE 800, which can communicate with different networks utilizing a first RAT and a second RAT. The UE 500 can perform an improved OOS scan procedure that can reduce the time and/or power used to acquire service from a suitable network. Referring to FIG. 5, the UE 500 has a first RAT access block 502 and a second RAT access block 504. The first RAT access block 502 can be used to communicate with a network utilizing a first RAT, and store a first MRU list 506 and/or a first neighbor list 508. The second RAT access block 504 can be used to communicate with a network utilizing a second RAT, and store a second MRU list 510 and/or a second neighbor list 512. The UE 500 further has a multimode manager block 514 for controlling, for example, the first RAT access block 502, second RAT access block 504, and other multi-RAT access related functions. For example, the multimode manager block 514 can determine how a shared communication resource 516 is shared and utilized by the first RAT access block 502 and second RAT access block 504 to transmit and/or receive signals to/from different networks. In some examples, the shared communication resource 516 may include one or more of radio frequency (RF) front end circuitry, amplifiers (e.g., low noise amplifier), digital-to-analog converters, analog-to-digital converters, filters, modulators, demodulators, encoders, decoders, and other generally known wireless communication components.

In addition, the UE 500 includes an OOS scanning block 518 configured to perform OOS scanning procedures. In this particular example, the OOS scanning block 518 includes an MRU list scanning block 520, a neighbor list scanning block 522, and a full scanning block 524. In one aspect of the disclosure, the UE 500 may utilize the OOS scanning block 518 to perform an OOS scan algorithm that can reduce the scanning time and/or power consumption used to acquire service. For example, if the UE 500 is engaged in a long voice call utilizing a first RAT (e.g., GSM), the UE may become OOS with respect to a second RAT (e.g., W-CDMA) at a certain time (e.g., time T2 of FIG. 1) while the voice call is still ongoing. Therefore, after the voice call, the UE 500 performs an OOS scan to reacquire service utilizing the second RAT.

At the beginning of the OOS scan, the UE 500 scans the networks stored in the MRU list 510 first. If the UE fails to acquire service (i.e., found a valid channel) after scanning the MRU list 510, the UE 500 then scans the channels, frequencies, and/or bands stored in the second neighbor list 512. In this example, the UE 500 previously stored the neighbor cells information broadcasted from the networks in the first and/or second neighbor lists 508, 512 before the UE initiated the voice call with the first RAT. If the UE 500 is still within the neighboring area or proximity where the voice call was started, it is likely that the UE 500 will find a suitable network or system to acquire service while scanning the second neighbor list 512. It is because if the UE 500 has not moved too far from the original location when the call was started, the UE will be still within the coverage area of one or more of the networks stored in the neighbor list 512. However, if the UE 500 fails to reacquire service after scanning the second neighbor list 512, it can perform a wider scan or a full scan. The wider or full scan list building logic may be any known scan list building logic depending on the particular RAT being used. For example, during the full scan or wider scan, the UE may scan the channels and/or bands allowed by the UE's subscription, in an order provided in the subscription and/or in the same geographical area depending on the technology. The various components, blocks, and/or circuitry of the UE 500 may be implemented in hardware, firmware, software, and any combinations thereof.

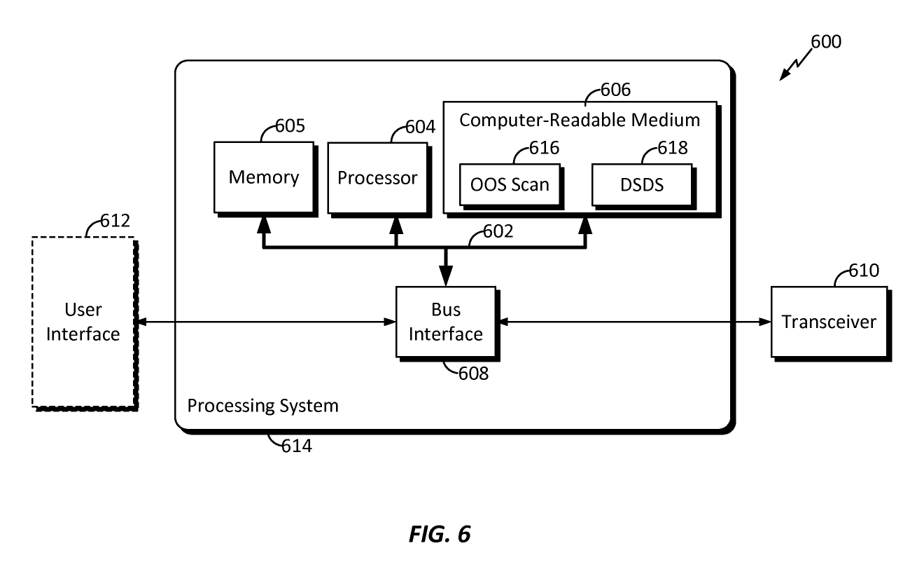

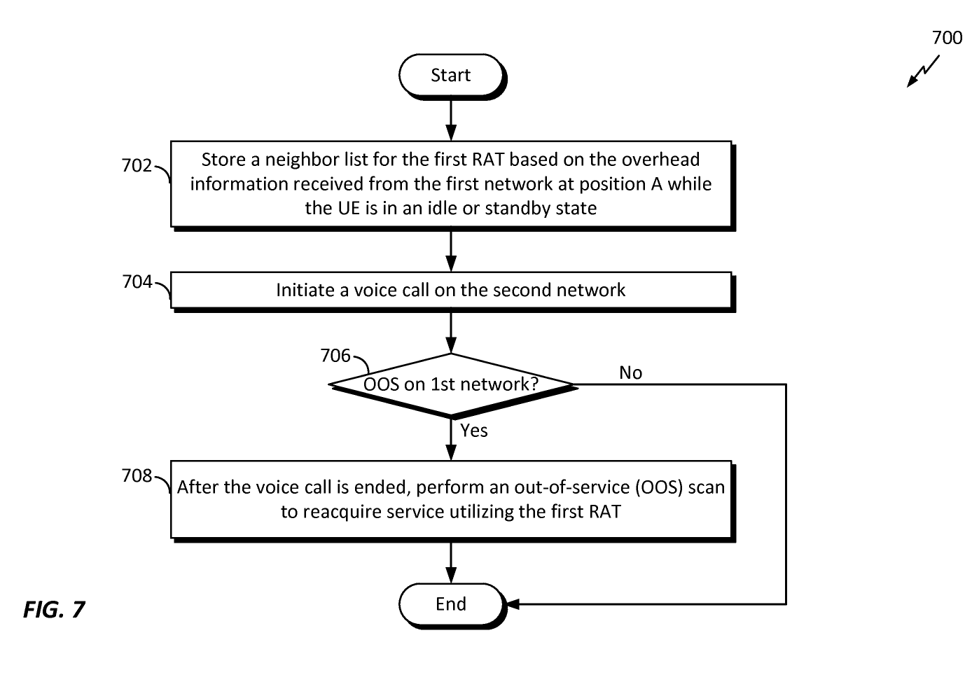

FIG. 6 is a conceptual diagram illustrating an example of a hardware implementation for an apparatus 600 employing a processing system 614. In accordance with various aspects of the disclosure, an element, or any portion of an element, or any combination of elements may be implemented with a processing system 614 that includes one or more processors 604. In some examples, the apparatus 600 may be a UE as illustrated in any one or more of FIGS. 2-5 and/or 8. In another example, the apparatus 600 may be a Node B or an RNC as illustrated in FIG. 3. Examples of processors 604 include microprocessors, microcontrollers, digital signal processors (DSPs), field programmable gate arrays (FPGAs), programmable logic devices (PLDs), state machines, gated logic, discrete hardware circuits, system-on-a-chip, and other suitable hardware configured to perform the various functionality described throughout this disclosure. That is, the processor 604, as utilized in an apparatus 600, may be used to implement any one or more of the methods, procedures, algorithms, and processes described and illustrated in FIGS. 7-11.

In this example, the processing system 614 may be implemented with a bus architecture, represented generally by the bus 602. The bus 602 may include any number of interconnecting buses and bridges depending on the specific application of the processing system 614 and the overall design constraints. The bus 602 links together various circuits or components including one or more processors (represented generally by the processor 604), a memory 605, and computer-readable media (represented generally by the computer-readable medium 606). The bus 602 may also link various other circuits such as timing sources, peripherals, voltage regulators, and power management circuits, which are well known in the art, and therefore, will not be described any further. A bus interface 608 provides an interface between the bus 602 and a transceiver 610. In some aspects of the disclosure, the apparatus 600 may have one or more transceivers that are generally represented as the transceiver 610. The transceiver 610 provides a means for communicating with various other apparatus over a transmission medium. Depending upon the nature of the apparatus, a user interface 612 (e.g., keypad, display, speaker, microphone, joystick, touchpad, touchscreen, gesture sensor, position and motion sensor) may also be provided.

The processor 604 is responsible for managing the bus 602 and general processing, including the execution of software stored on the computer-readable medium 606. The software, when executed by the processor 604, causes the processing system 614 to perform the various functions described below for any particular apparatus. The computer-readable medium 606 may also be used for storing data that is manipulated by the processor 604 when executing software. In one aspect of the disclosure, the software may include an OOS scan software 616 that when executed by the processor causes the apparatus 600 to perform the OOS scan algorithm described in relation to FIGS. 7-11 below. The various components and/or circuitry of the apparatus 600 may be implemented in hardware, firmware, software, and any combination thereof. In one aspect of the disclosure, the software may include a DSDS software 618 together with the OOS software 616 that when executed by the processor 604, can implement the various blocks and components of the UE 500 illustrated in FIG. 5 and their functions.

One or more processors 604 in the processing system may execute various software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 606. The computer-readable medium 606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 606 may reside in the processing system 614, external to the processing system 614, or distributed across multiple entities including the processing system 614. The computer-readable medium 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

FIG. 7 is a flow chart illustrating an OOS scan method 700 operable at a UE in accordance with aspects of the disclosure. In some examples, the method 700 may be performed by any of the UEs illustrated in FIGS. 2-6 and/or 8. In one particular example, the method 700 may be performed by a DSDS UE 800 illustrated in FIG. 8. The UE 800 may be the same as any of the UEs illustrated in FIGS. 2-6. The UE 800 can communicate with a first network and a second network utilizing a first RAT 804 and a second RAT 802, respectively. It is assumed that the UE 800 was initially in a standby or idle mode while camped on both networks. In addition, the UE 800 received overhead information including neighbor list information from one or both networks associated with the different RATs. Referring to FIG. 7, at block 702, the UE 800 stores and/or maintains a neighbor list 806 (FIG. 8) for the first RAT 804 based on the overhead information received from the first network at position A while the UE is in an idle or standby state (for both RATs). In this example, the UE may utilize the first RAT access block 502 (see FIG. 5) to communicate with the network associated with the first RAT. The stored neighbor list 806 may be the same as the neighbor list 508 of FIG. 5. In one example, the neighbor list 806 has one or more entries for the channels, frequencies and/or bands of neighboring cells with respect to position A. In this particular example, the neighbor list 806 may have records for an Absolute Radio Frequency Channel Number (ARFCN) 798 and others ARFCNs. The ARFCN 798 is a channel of the first network associated with the first RAT 804.

At block 704, the UE initiates a voice call on the second network utilizing the second RAT 802. In this example, the UE may utilize the second RAT access block 504 (see FIG. 5) to initiate the voice call on the second network. In some aspects of the disclosure, the UE 800 may not be able to transmit and/or receive signals utilizing the first RAT 804 while the voice call is ongoing. Therefore, if the voice call lasts for a long time, the UE 800 may become OOS with respect to the first RAT 804 at a certain time (e.g., time T2 of FIG. 1). In one example, if the voice call sustains for more than one minute, the UE 800 may consider the first RAT 804 to be OOS because of unavailability of RF resources. At decision block 706, if it is determined that the UE 800 is OOS with respect to the first RAT 804, the method 700 proceeds to block 708; otherwise, the method 700 proceeds to the end block.

At block 708, after the voice call is ended, the UE can perform an OOS scan to reacquire service utilizing the first RAT. In this example, the UE may utilize one or more of the multimode manager block 514, the first RAT access block 502, the OOS scanning block 518, and/or the shared communication resource block 516, to perform the OOS scan. However, during the voice call, the UE 800 might have moved to the position B where the UE is no longer within the coverage area of ARFCN 797. Therefore, the UE will not be able to reacquire service by scanning an MRU list 808 that includes entries for ARFCNs 797 and 788, but not ARFCN 798, for example.

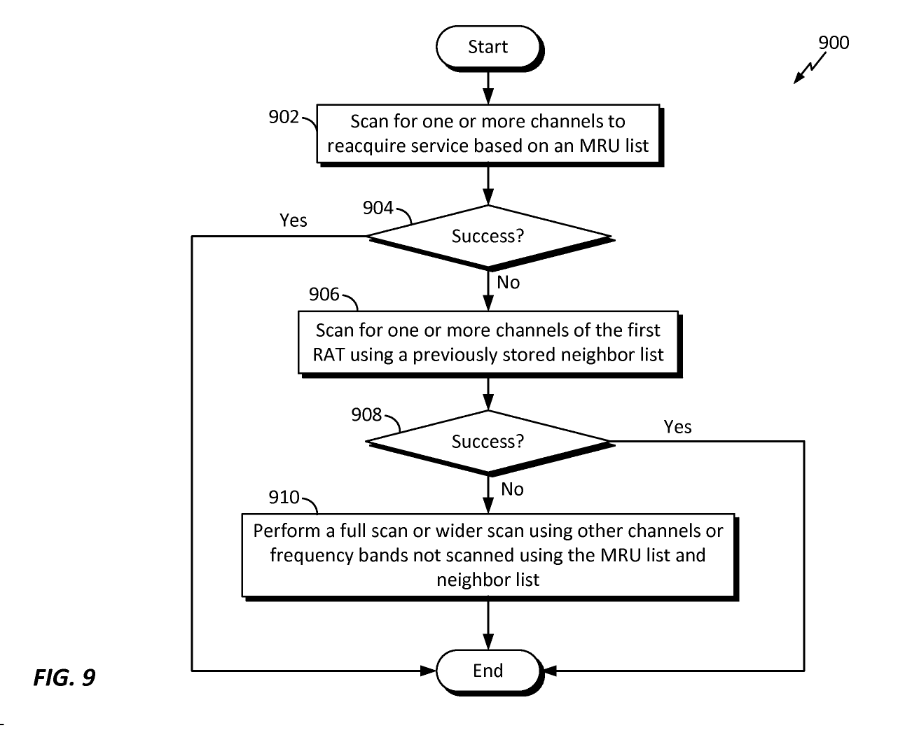

FIG. 9 is a flow chart illustrating an OOS scan method 900 utilizing neighbor list information to reduce scan time and/or power consumption in accordance with aspects of the disclosure. In some aspects of the disclosure, the OOS scan method 900 may be performed by any of the UEs illustrated in FIGS. 2-6 and/or 8. In one particular example, the OOS scan method 900 may be performed by the UE 500 or UE 800 that utilize a first RAT and a second RAT for wireless communication with the associated networks. Here, it is assumed that the UE became OOS with respect to a first RAT (e.g., first RAT 804 of FIG. 8) after a long voice call using a second RAT (e.g., second RAT 802 of FIG. 8). In one aspect of the disclosure, the UE performs the OOS scan method 900 to reacquire service. In UMTS networks, for example, the UE acquires and/or demodulates the Primary Synchronization Channel (P-SCH), Secondary Synchronization Channel (S-SCH), Common Pilot Channel (CPICH), and Primary Common Control Physical Channel (PCCPCH) in order to acquire service. The acquisition or demodulation of these channels depends on their assigned power, channel conditions, performance of the UE, etc.

At block 902, the UE scans for one or more channels (i.e., acquiring or demodulating the channels of a system/network) to reacquire service based on an MRU list. In one example, the MRU list may be the MRU list 808 (see FIG. 8) that stores network information on the most recently used channels of the first RAT and/or second RAT. In this particular example, the MRU list includes the ARFCNs 797 and 788 channels (see FIG. 8). In this case, the UE recently used the ARFCN 797 channel for the first RAT and the ARFCN 788 channel for the second RAT. When the UE moved from the position A to position B, the ARFCN 797 channel was no longer a valid channel for communicating with the network of the first RAT.

At decision block 904, if the UE successfully acquire service utilizing the first RAT, the method 900 proceeds to the end block; otherwise if failed, the method 900 proceeds to block 906. At block 906, the UE scans for one or more channels of the first RAT using a previously stored neighbor list (e.g., neighbor list 806 of FIG. 8). In this particular example, the neighbor list may have an entry for ARFCN 798, which is a valid channel of the first RAT for acquiring service when the UE is at the position B. Therefore, the stored neighbor list can help the UE find a valid channel of the first RAT without performing a full or wider scan, thus reducing time and/or power consumption used for service acquisition.

At decision block 908, if the UE still fails to acquire service utilizing the first RAT, the method 900 proceeds to block 910; otherwise, it proceeds to the end block. At block 910, the UE may perform a full scan or a wider scan using other channels or frequency bands not scanned using the MRU list and neighbor list. The scan list for the full scan or wider scan may be built using any known scan list building logic that may vary from technology to technology. For example, during the full scan or wider scan, the UE scans the channels and/or bands allowed by the UE's subscription, in an order provided in the subscription and/or in the same geographical area depending on the technology.

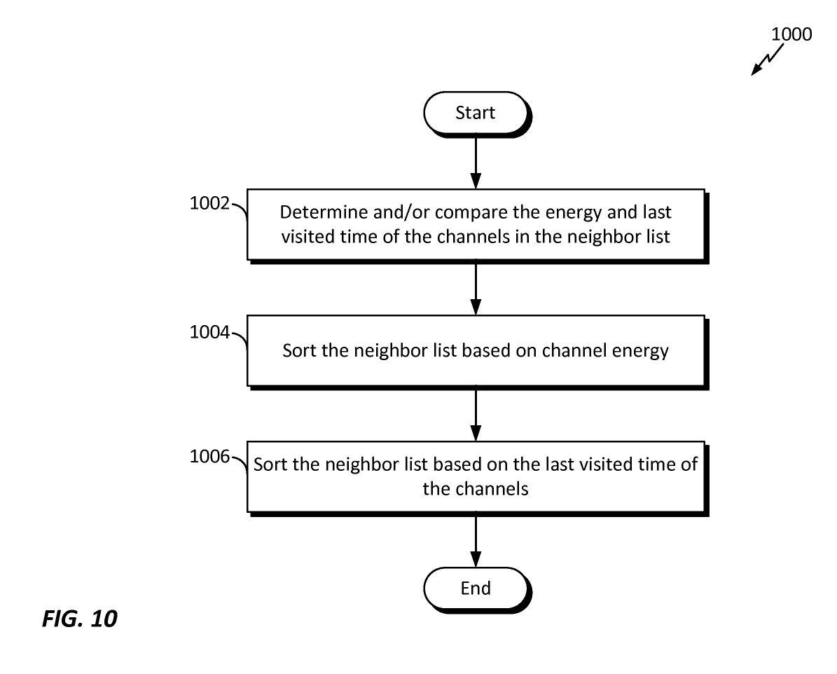

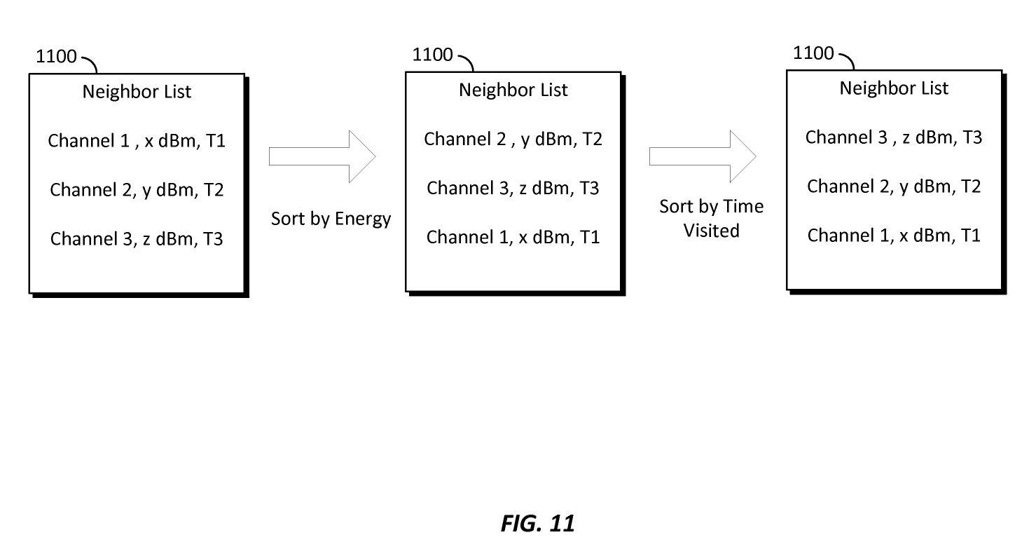

FIG. 10 is a drawing illustrating a method 1000 of maintaining a neighbor list in accordance with an aspect of the disclosure. In some aspects of the disclosure, the method 1000 may be performed by any of the UEs illustrated in FIGS. 2-6, and/or 8. FIG. 11 is a drawing illustrating a neighbor list 1100 sorted using the method 1000 of FIG. 10. For example, the neighbor list 1100 may be any of the neighbor lists illustrated in FIGS. 5 and/or 8. Initially, in a non-limiting example, the neighbor list 1100 may have entries for three channels: channels 1, 2, and 3. Channel 1 has an energy of x dBm and was lasted visited by the UE at time T1 (last-visited time). Similarly, the energy and last visited time of channels 2 and 3 are y dBm and z dBm, and time T2 and T3, respectively. In one example, during an OOS scan, the UE will start scanning from the topmost channel (e.g., channel 1) in the neighbor list and proceed down the list to the next channel below until a valid channel is found or the list is exhausted.

Referring to FIG. 10, at block 1002, the UE inspects or processes the neighbor list 1100 so that it can determine and/or compare the energy and last visited time of the channels in the neighbor list. In one example, the UE may utilize the first RAT access block 502 or second RAT access block 504 to inspect and/or process the neighbor lists. At block 1004, the UE may sort the neighbor list based on channel energy. In this particular example, channels 2 and 3 may have greater energy than channel 1 (i.e., y and z>x). Therefore, after sorting, channel 2 and 3 become the first and second channels in the neighbor list 1100, and channel 1 becomes the third channel. At block 1006, the UE may further sort the neighbor list 1100 based on the last visited time of the channels. In one example, the last visited time of channel 3 is earlier than that of channel 2. Therefore, after sorting, channel 3 becomes the first channel, and channel 2 becomes the second channel in the neighbor list.

In other aspects of the disclosure, the UE may sort the neighbor list 1100 based on the last visited time first then followed by sorting according to channel energy. In some other aspects of the disclosure, the UE may sort the neighbor list based on any combinations and/or orders of channel energy, last visited time, and other suitable criteria.

Several aspects of a telecommunications system have been presented with reference to a DSDS UE and an exemplary communication system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-10 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for performing an out-of-service (OOS) scan at a user equipment (UE), comprising:
scanning one or more first channels to acquire service based on a most recently used (MRU) list;
if the UE fails to acquire service after scanning the one or more first channels, scanning one or more second channels to acquire service based on a neighbor list; and
if the UE fails to acquire service after scanning the one or more second channels, scanning a plurality of third channels not included in the MRU list and the neighbor list.

2. The method of claim 1, further comprising:
determining the neighbor list based on information received from a first network utilizing a shared communication resource; and
communicating with a second network utilizing the shared communication resource before the UE is OOS on the first network.

3. The method of claim 2, wherein the communicating on the second network comprises engaging in a voice call on the second network.

4. The method of claim 3, wherein the voice call comprises a circuit-switched fallback call on the second network.

5. The method of claim 2, wherein the first network is associated with a first radio access technology (RAT), and the second network is associated with a second RAT that is different from the first RAT.

6. The method of claim 1, further comprising:
sorting the one or more second channels of the neighbor list based on at least one of channel energy or a last-visited time; and
scanning the one or more second channels based on their sorted order.

7. The method of claim 1, wherein the one or more third channels comprise at least one of:
one or more channels permitted in a subscription associated with a first network; or
one or more channels available in a same geographical area as the first network.

8. An apparatus configured to perform an out-of-service (OOS) scan, comprising:
means for scanning one or more first channels to acquire service based on a most recently used (MRU) list;
means for if the apparatus fails to acquire service after scanning the one or more first channels, scanning one or more second channels to acquire service based on a neighbor list; and
means for if the apparatus fails to acquire service after scanning the one or more second channels, scanning a plurality of third channels not included in the MRU list and the neighbor list.

9. The apparatus of claim 8, further comprising:
means for determining the neighbor list based on information received from a first network utilizing a shared communication resource; and
means for communicating with a second network utilizing the shared communication resource before the UE is OOS on the first network.

10. The apparatus of claim 9, wherein the means for communicating on the second network comprises means for engaging in a voice call on the second network.

11. The apparatus of claim 10, wherein the voice call comprises a circuit-switched fallback call on the second network.

12. The apparatus of claim 9, wherein the first network is associated with a first radio access technology (RAT), and the second network is associated with a second RAT that is different from the first RAT.

13. The apparatus of claim 8, further comprising:
means for sorting the one or more second channels of the neighbor list based on at least one of channel energy or a last-visited time; and
means for scanning the one or more second channels based on their sorted order.

14. The apparatus of claim 8, wherein the one or more third channels comprise at least one of:
one or more channels permitted in a subscription associated with a first network; or
one or more channels available in a same geographical area as the first network.

15. A computer-readable storage medium comprising code for causing a user equipment (UE) to perform an out-of-service (OOS) scan, comprising:
code for causing the UE to scan one or more first channels to acquire service based on a most recently used (MRU) list;
code for causing the UE to if the UE fails to acquire service after scanning the one or more first channels, scan one or more second channels to acquire service based on a neighbor list; and
code for causing the UE to if the UE fails to acquire service after scanning the one or more second channels, scan a plurality of third channels not included in the MRU list and the neighbor list.

16. The computer-readable storage medium of claim 15, further comprising code for causing the UE to:
determine the neighbor list based on information received from a first network utilizing a shared communication resource; and
communicate with a second network utilizing the shared communication resource before the UE is OOS on the first network.

17. The computer-readable storage medium of claim 16, wherein the code for causing the UE to communicate on the second network comprises code for causing the UE to engaging in a voice call on the second network.

18. The computer-readable storage medium of claim 17, wherein the voice call comprises a circuit-switched fallback call on the second network.

19. The computer-readable storage medium of claim 16, wherein the first network is associated with a first radio access technology (RAT), and the second network is associated with a second RAT that is different from the first RAT.

20. The computer-readable storage medium of claim 15, further comprising code for causing the UE to:
sort the one or more second channels of the neighbor list based on at least one of channel energy or a last-visited time; and
scan the one or more second channels based on their sorted order.

21. The computer-readable storage medium of claim 15, wherein the one or more third channels comprise at least one of:
one or more channels permitted in a subscription associated with a first network; or
one or more channels available in a same geographical area as the first network.

22. A user equipment (UE) configured to perform an out-of-service (OOS) scan, comprising:
at least one processor;
a shared communication resource coupled to the at least one processor for communicating with a first network and a second network; and
a memory coupled to the at least one processor, wherein the memory comprises an OOS scan program;
wherein the processor is configured by the OOS scan program to:
scan one or more first channels to acquire service based on a most recently used (MRU) list;
if the UE fails to acquire service after scanning the one or more first channels, scan one or more second channels to acquire service based on a neighbor list; and
if the UE fails to acquire service after scanning the one or more second channels, scan a plurality of third channels not included in the MRU list and the neighbor list.

23. The UE of claim 22, further comprising:
a first RAT access block configured to determine the neighbor list based on information received from the first network utilizing the shared communication resource; and
a second RAT access block configured to communicate with the second network utilizing the shared communication resource before the UE is OOS on the first network.

24. The UE of claim 23, wherein for communicating on the second network, the second RAT access block is further configured to engage in a voice call on the second network.

25. The UE of claim 24, wherein the voice call comprises a circuit-switched fallback call on the second network.

26. The UE of claim 23, wherein the first network is associated with a first radio access technology (RAT), and the second network is associated with a second RAT that is different from the first RAT.

27. The UE of claim 22, wherein the OOS scanning block is further configured to:
sort the one or more second channels of the neighbor list based on at least one of channel energy or a last-visited time; and
scan the one or more second channels based on their sorted order.

28. The UE of claim 22, wherein the one or more third channels comprise at least one of:
one or more channels permitted in a subscription associated with the first network; or
one or more channels available in a same geographical area as the first network.
